(19) United States
(12) Patent Application Publication
(10) Pub. No.: US 2023/0051393 A1
(43) Pub. Date: Feb. 16, 2023

(54) POSITIONING APPARATUS WITH AN ASSOCIATED TRANSFER MECHANISM

(71) Applicant: RENISHAW PLC, Wotton-under-Edge, Gloucestershire (GB)

(72) Inventors: Stephen Paul HUNTER, Chipping Sodbury (GB); Michael John WOOLDRIDGE, Stroud (GB); Hugo George DERRICK, Stroud (GB); James Richard Philip HUNTLEY, Pensford (GB)

(73) Assignee: RENISHAW PLC, Wotton-under-Edge, Gloucestershire (GB)

(21) Appl. No.: 17/783,483

(22) PCT Filed: Dec. 14, 2020
(86) PCT No.: PCT/GB2020/053205

§ 371 Date: Jun. 8, 2022

(30) Foreign Application Priority Data
Dec. 19, 2019 (GB) 1918864.8

(51) Int. Cl. G01B 5/012; B66F 3/24; B66F 3/26

(52) U.S. Cl. CPC G01B 5/012; B66F 3/247; B66F 3/26

(57) ABSTRACT

An apparatus including an inspection apparatus for inspecting an artefact, and a transfer mechanism for moving a pallet on which an artefact is located relative to the inspection apparatus so as to move the pallet to and from an inspection location, and further including at least one pallet lifter which can be actuated between a retracted and an extended configuration, configured such that when a pallet is at the inspection location the at least one pallet lifter can be actuated to its extended configuration so as to engage with and lift the pallet and thereby decouple the pallet from the transfer mechanism.

This invention relates to an apparatus, such as an apparatus for performing a task on an artefact. In particular, this invention relates to a positioning apparatus with an associated transfer mechanism for moving a pallet to and from a task location (e.g. a location within the apparatus' operating volume at which a task on the artefact by the apparatus can take place). Such a transfer mechanism could be referred to as a “pallet loader”, and for example could be a conveyor pallet loader. This invention also relates to a piston for use in lifting a pallet to decouple the pallet from a pallet loader during the performance of a task on an artefact located on the pallet.

Transfer mechanisms/pallet loaders for positioning apparatus such as coordinate positioning apparatus, in particular coordinate measuring machines (CMMs) are known. For example, known conveyor pallet loaders comprise a conveyor which sits within the CMM's inspection volume and can be used to move a pallet (and an artefact thereon) into and out of an inspection position/location. Known conveyor pallet loaders are attached to the CMM's table and are configured such that when the pallet is at the inspection position, the conveyor is caused to drop (e.g. by actuating pistons which support the conveyor), so that the pallet comes to sit on a plurality of (e.g. three) static pallet supports which are rigidly fixed to the CMM's table/base, thereby decoupling the pallet from the conveyor and ensuring a solid, stable, kinematic connection between the artefact and the CMM's metrology loop. When inspection has completed, the conveyor is raised, causing the conveyor to reengage the pallet and to lift the pallet off the static pallet supports, such that the conveyor can move the pallet away from the inspection location.

The present invention relates to an improved configuration.

According to a first aspect of the invention there is provided a system comprising an apparatus (in particular inspection apparatus) for performing a task on (in particular inspecting) an artefact, and a transfer mechanism via which a pallet on which an artefact is located relative to the inspection apparatus can be moved to and from a task (in particular inspection) location. The apparatus further comprises at least one pallet lifter which can be actuated between a retracted and an extended configuration, configured such that when a pallet is at the task (in particular inspection) location the at least one pallet lifter can be actuated to its extended configuration so as to engage with and lift the pallet and thereby decouple the pallet from the transfer mechanism.

Providing a pallet lifter which lifts the pallet off the transfer mechanism avoids the need to drop (and raise) the transfer mechanism itself. Especially in larger machines, and for systems in which heavy parts are to be transported by the transfer mechanism, the transfer mechanism itself can be very heavy, and this can in turn require a heavy-duty lifting mechanism, which can be costly, bulky, require significant power to operate, and potentially hazardous (e.g. due to finger-trap risks). The present invention avoids the need to provide a lifting mechanism for the transfer mechanism, thereby helping overcome such issues. Furthermore, this can significantly simplify the transfer mechanism's design and/or increase the design freedom for the transfer mechanism and/or inspection apparatus.

Preferably, when the at least one pallet lifter is actuated to its extended configuration so as to lift the pallet, the pallet and the transfer mechanism are decoupled (i.e. physically/mechanically decoupled), e.g. so as to reduce the transfer of vibrations from the transfer mechanism and surrounding environment to the pallet (and preferably so as to substantially isolate the pallet from such vibrations). For example, when the at least one pallet lifter is actuated to its extended configuration so as to lift the pallet, the pallet is detached/disconnected from the transfer mechanism.

As will be understood, an inspection apparatus typically comprises a movement frame for moving an inspection device relative to the artefact being inspected. The movement frame could comprise, for example, a gantry, cantilever, arm, portal, parallel-kinematic, hexapod motion platform or bridge type movement frame. The inspection device could be a contact or non-contact inspection device. The inspection device could be configured for measuring/determining the position of one or more points on the artefact. For example, the inspection device could comprise what are commonly referred to as a contact probe. A contact probe typically comprises a body which is mounted/mountable on the inspection apparatus, and a stylus extending from the body. Typically, a contact tip (e.g. a “stylus ball”) is provided at the free end of the stylus for contacting an artefact. Known contact probes include so-called “touch-trigger probes” (which are configured to output a trigger signal when the stylus has defected from a rest position), and also what are commonly known as “scanning probes” or “analogue probes” (which are configured to output a signal which varies depending on the amount by which the stylus has deflected from its rest position).

As is well known within the field of measuring apparatus, it is important to hold an artefact in a stable configuration during inspection. Typically, an artefact is connected to ground via a “base” or a “support frame” which holds the artefact in a stable configuration. In the case where the artefact is loaded/fixed on a pallet, typically the pallet is connected to ground via a base/support frame during inspection. The movement frame could be connected to ground via the same base/support frame, although this need not necessarily be the case and the movement frame could be connected to ground independently from the base/support frame which supports the artefact. In the field of traditional cartesian CMMs, the base/support frame is commonly referred to as a “table”. Often, but not necessarily, such a table is a granite table.

The at least one pallet lifter (e.g. the pallet lifter's “housing”—see below) could be mounted on the base/support frame. Accordingly, when the at least one pallet lifter engages the pallet, the pallet is coupled to the base/support frame via the at least one pallet lifter.

Preferably, the transfer mechanism is decoupled (i.e. physically/mechanically) from the inspection apparatus. Preferably, the transfer mechanism is decoupled (i.e. physically/mechanically) from the base/support frame. Accordingly, preferably, the transfer mechanism is connected to ground independently from the inspection apparatus and/or the base/support frame. Accordingly, the transfer mechanism could be arranged such that it is not physically/mechanically connected to the inspection apparatus and/or the base/support frame. The transfer mechanism could be held such that it is held above the base/support frame (such that there is a gap between the transfer mechanism and the base/support frame). Accordingly, the transfer mechanism could be connected to ground (e.g. supported on the floor) independently of the inspection apparatus and/or base/support frame (e.g. supported on the floor independently of the base/support frame). Accordingly, the transfer mechanism could bridge the base/support frame.

Preferably, the at least one pallet lifter is pneumatically operated. Accordingly, the apparatus can comprise a pneumatic system (for example, a compressed air source) connected to the at least one pallet lifter. Preferably, the at least one pallet lifter is configured to be actuated towards its extended configuration pneumatically. Optionally, the pallet lifter is configured to be biased into its retracted configuration mechanically. Optionally, the pallet lifter comprises at least one (mechanical) spring configured to bias the pallet lifter to its retracted configuration. Although the pallet lifter could comprise at least one (mechanical) spring configured to assist the lifting of a pallet by the pallet lifter (in other words at least one (mechanical) spring configured assist actuation of the pallet lifter to its extended configuration), it can be preferred that all lifting of the pallet is achieved pneumatically.

The at least one pallet lifter can comprise a housing and a member. The member can be moved/actuated between (and held at) a retracted/lowered position and an extended/raised position (relative to the housing). The member can be moved/actuated along an axis/straight line between the retracted/lowered and extended/raised positions. In its extended/raised position, the member can extend from the housing (more than it does in its retracted position). Optionally, (but not necessarily) the member can project/extend out of the housing in its retracted/lowered position, albeit by a smaller amount than when it is in its extended/raised position. In use, in its extended/raised position, the member can be configured to interact with a pallet located above the pallet lifter on the transfer mechanism, so as to lift the pallet. For example, the member can push against a pallet, so as to lift the pallet. The member could be referred to as a “prop”.

Preferably, a stop (member) is provided to control the position of the member in its extended/raised position (i.e. its position along the axis/straight line of movement of the member). For example, in its extended/raised position, a part of the pallet lifter's member can be biased/urged against the stop. Accordingly, the interaction between the pallet lifter's member and the stop can control the position of the member in its extended/raised position. Also, advantageously, biasing the pallet lifter's member against the stop facilitates a stable configuration for the pallet lifter's member, which in turn facilitates a stable mount for the pallet during inspection. Accordingly, preferably, in the extended configuration, the pallet lifter's member is urged so that it is biased against the stop. Accordingly, the pallet lifter's member needs to be biased/urged with sufficient force so as to overcome the weight of the pallet and artefact thereon and maintain contact with the stop during inspection.

The stop could be provided by the housing. The stop could be provided on the inside of the housing. The stop could be provided by a structure which is separate to the pallet lifter's housing. For, instance, the stop could be provided by a shroud which sits over the pallet lifter's housing. Either way (whether the stop is provided by the pallet lifter's housing or a structure separate to the housing), it is advantageous that the pallet lifter's member is itself biased against the stop (i.e. directly) (c.f., for example, where the pallet is biased against a stop). This is because a much more mechanically rigid and stable connection to ground can be provided. In particular, directly biasing the pallet lifter's member against the stop can provide as straight as possible metrology loop, with the fewest components to help avoid a stack up of error. Furthermore, combining the stop and the member in a closely located housing, the pallet size and configuration is less limited

At least one of the stop and the pallet lifter member can comprise one or more distinct (e.g. projecting/recessed) features, which cooperate with the other in order to define/control the position of the member in its extended/raised position. The pallet lifter member can comprise a face which is biased against the stop. In accordance with the language below, the stop could comprise features for defining the discrete engagement locations.

The pallet lifter member could comprise at least one firm feature configured to cooperate with the stop (to define the position of the member in its extended/raised position). Such a feature on the pallet lifter member could be a firm planar/flat surface (e.g. face), a firm projecting feature (such as a finger, lug, spherical feature, raised ring, raised pad/seat, or the like), or a firm recessed feature (such as a dip, a channel, groove, or the like). The corresponding stop could comprise at least one complementary feature (such as a firm planar/flat surface, firm projecting feature or recessed feature) for interacting with the feature on the pallet lifter member. In accordance with the language below, such features (and complementary features) can be provided at/define the engagement locations. Both the at least one feature on the pallet lifter member and the stop's at least one complementary feature could both comprise projecting features. For instance, the member could comprise an annularly extending raised ring feature which is configured to cooperate with (e.g. be biased against/engage) three annularly spaced, raised pads/seats provided on the stop (or vice versa). Optionally, the feature on the pallet lifter member or the complementary feature on the stop is not a projecting or recessed feature. For instance, the feature on the pallet lifter member could comprise a planar feature (e.g. such as a flat face) which is configured to interact with one or more projecting feature(s) on the stop (or vice versa).

The position of the pallet lifter member in its extended/raised position can be controlled by a plurality of (preferably three) discrete engagement locations provided by/between the actuator and the stop. In accordance with the language above, the discrete engagement locations can each comprise at least one protruding feature on one of the pallet lifter member and stop. The discrete engagement locations can be spaced annularly around the member (e.g. around the member's axis), for example, be equidistantly spaced annularly around the member. Whilst more than three engagement locations can be provided, providing only three engagement locations can advantageously provide a more stable configuration.

Preferably, the discrete engagement locations provide a kinematic link/joint between the pallet lifter member and the stop. Accordingly, preferably, the discrete engagement locations provide for only six points of contact between the pallet lifter member and the stop for constraining the relative position of the member and stop in all six degrees of freedom (three linear and three rotational degrees of freedom). For instance, each of the discrete engagement locations could provide two points of contact between the pallet lifter member and stop. Alternatively, a first engagement location can provide one point of contact, a second point of contact can provide two points of contact and a third engagement location can provide three points of contact. As will be understood, providing greater than six points of contact can result in the pallet lifter member and stop being over constrained, leading to reduced stability and reduced repeatability.

The at least one pallet lifter can comprise a piston device. The piston device can comprise a housing and a piston. Accordingly, the above-mentioned and described “pallet lifter member” could be a piston, and features and aspects of the invention referred to above in connection with the “pallet lifter member” are equally applicable here. For instance, the piston could comprise a piston rod which projects from the housing. As per the above description of the “pallet lifter member”, the piston (e.g. the piston rod) can be moved between (and held at) retracted/lowered and extended/raised positions. The piston (e.g. piston rod) can be configured to interact with a pallet, so as to lift the pallet, in its extended configuration. The piston could comprise a piston disc (as well as the piston rod). The piston disc could reside in a chamber in the housing. In this case, the piston disc can be configured to interact with the stop. For instance, the piston disc could comprise the at least one feature (e.g. such as a raised ring) configured to cooperate with the stop (to define the position of the member in its extended/raised position). Accordingly, the stop can be provided on the inside of the housing.

The transfer mechanism can guide the motion of the pallet with respect to the inspection apparatus (to and from the inspection location). Preferably, a pallet sits on the transfer mechanism. The transfer mechanism can comprise a support structure on which a pallet is supported, to and from the inspection location. The support structure could comprise a table or bridge-like structure, over which a pallet travels/rides to and from the inspection location. The support structure could be supported on the floor by one or more legs. The transfer mechanism (e.g. the support structure) could comprise one or more guideways, bearings and/or rails for guiding a pallet to and from the inspection location.

At least part of the transfer mechanism (e.g. at least part of the aforementioned table/bridge) can at least be positioned within the operating volume of the inspection apparatus. Accordingly, the transfer mechanism could extend across the inspection apparatus. For instance, in those embodiments in which the inspection apparatus has a base, the transfer mechanism can bridge/span the base of the inspection apparatus. Preferably, the transfer mechanism is decoupled from the inspection apparatus. Preferably, the transfer mechanism is connected to ground independently from the inspection apparatus (e.g. independently from its base). For example, the transfer mechanism can be supported on the floor independently from the inspection apparatus.

Optionally, the transfer mechanism drives the motion of the pallet with respect to the inspection apparatus (to and from the inspection location). Accordingly, the transfer mechanism could comprise one or more actuators (e.g. motors) for moving a pallet loaded thereon. The transfer mechanism could comprise a conveyor mechanism. Accordingly, the transfer mechanism could comprise one or more belts on which the pallet rides. Accordingly, the transfer mechanism could comprise what is commonly referred to as a “conveyor pallet loader”.

The apparatus could be described as having a pallet lifting arrangement comprising a plurality of pallet lifters. Preferably, the apparatus comprises three pallet lifters located so as to interact with and lift a pallet at three separate locations. The three pallet lifters and the pallet can be configured such that when they are interacting, a kinematic link/joint between the pallet lifting arrangement (i.e. the pallet lifters) and the pallet is provided. Accordingly, the pallet is kinematically located with respect to the pallet lifters. Ultimately, this provides a kinematic link/joint between the pallet and ground (e.g. a kinematic link/joint between the pallet the aforementioned base). Accordingly, in line with the above, the three pallet lifters and the pallet could be configured such that when the pallet lifters interact with the pallet, there are only six points of contact between all the pallet lifters and the pallet which constrain the location of the pallet in all six degrees of freedom.

This application also describes an apparatus comprising an inspection apparatus for inspecting an artefact, and a transfer mechanism for moving a pallet on which an artefact is located relative to the inspection apparatus so as to move the pallet to and from an inspection location, in which the transfer mechanism is decoupled from the inspection apparatus. In other words, the transfer mechanism is connected to ground (e.g. supported on the floor) independently from the inspection apparatus such that they do not contact/touch each other.

According to another aspect of the invention there is provided a pneumatically operable actuator/piston device (e.g. pallet lifter), comprising a housing which houses a member (e.g. piston) which extends from the housing (e.g. a piston rod), and which can be moved between a retracted and an extended position, in which the rest position of the member (e.g. of the piston) at its extended position is controlled by three discrete, annularly spaced, engagement locations provided by/between the member (e.g. the piston) and a stop (e.g. stop surface/member). Features of the pallet lifter described in connection with the first aspect of the invention are equally applicable to the pneumatically operable actuator/piston device of this aspect of the invention.

According to another aspect of the invention there is provided an actuator/piston device (e.g. pallet lifter), comprising a housing which houses a member (e.g. piston) which extends from the housing (e.g. a piston rod), and which can be moved between a retracted and an extended position, comprising at least one electrical connector provided on the part of the member (e.g. piston rod) that is external of the housing, for moving therewith. Accordingly, the electrical connector on the member (e.g. piston rod) can connect to a corresponding electrical connector provided on a component separate to the actuator/piston device (e.g. such as on a pallet). Features of the pallet lifter described in connection with the first aspect of the invention are equally applicable to the actuator/piston device of this aspect of the invention.

According to another aspect of the invention there is provided an apparatus comprising a transfer mechanism for moving a pallet, and at least one pallet lifter which can be actuated between a retracted and an extended configuration, configured such that when the pallet is located over the at least one pallet lifter, the at least one pallet lifter can be actuated to its extended configuration so as to engage with and lift the pallet and thereby decouple the pallet from the transfer mechanism. The pallet can comprise at least one electrical connector on its underside. At least one of the at least one pallet lifters can comprise at least one electrical connector configured such that when the pallet lifter is in its extended configuration the pallet's and the pallet lifter's at least one electrical connectors can contact and electrically connect with each other. The electrical connector can be provided on (e.g. mounted on, for instance clamped on) the part of the pallet lifter which engages with the pallet so as to lift the pallet (e.g. on the above described pallet lifter member/piston/piston rod). Features of the pallet lifter described in connection with the first aspect of the invention are equally applicable to the pallet lifter of this aspect of the invention.

Embodiments of the invention will now be described, by way of example only, with reference to the following drawings, in which:

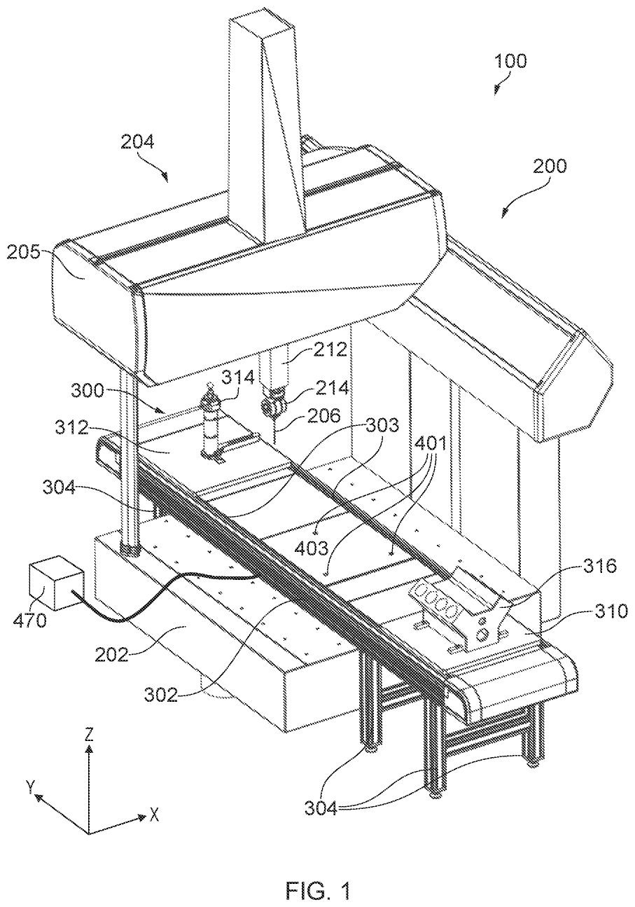

FIG. 1 illustrates an apparatus according to the present invention, comprising a Coordinate Measuring Machine (CMM), a transfer mechanism for transferring a pallet to and from an inspection location, and pallet lifters for lifting the pallet from the transfer mechanism at the inspection location;

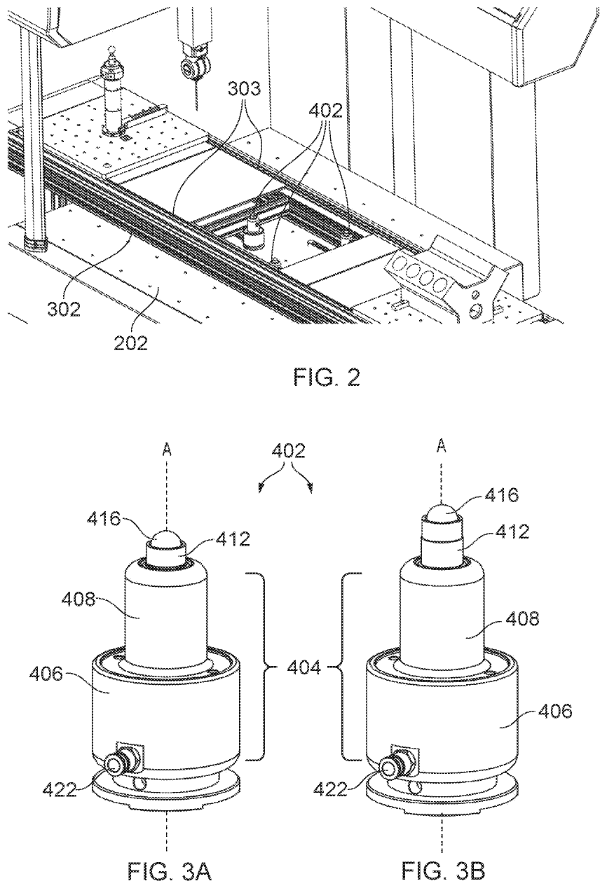

FIG. 2 illustrates a close-up view of the pallet lifters of the apparatus of FIG. 1;

FIGS. 3a and 3b respectively illustrate a pallet lifter in a retracted and extended configuration;

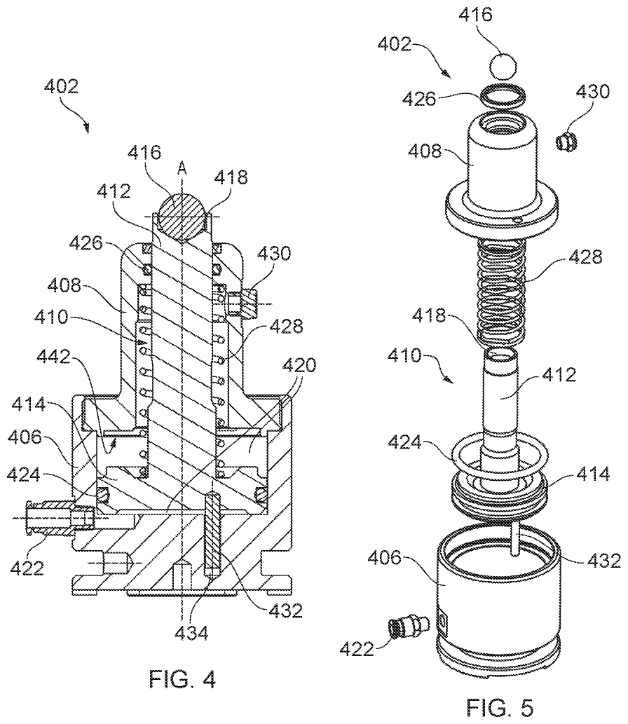

FIG. 4 illustrates a cross-sectional view of a pallet lifter;

FIG. 5 illustrates an exploded component view of a pallet lifter;

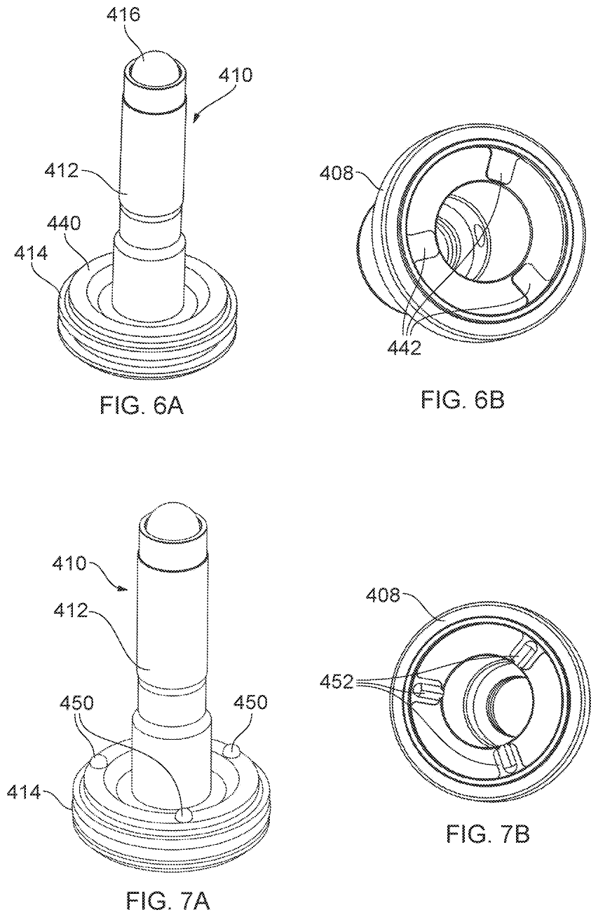

FIGS. 6a and 6b respectively illustrate an isometric top view of the piston of a pallet lifter according to a first embodiment of the invention, and a view into the underside of the pallet lifter's neck part with its three landing pads/seats;

FIGS. 7a and 7b respectively illustrate an isometric top view of the piston of a pallet lifter according to a second embodiment of the invention, and a view into the underside of the pallet lifter's neck part with its three kinematic V features;

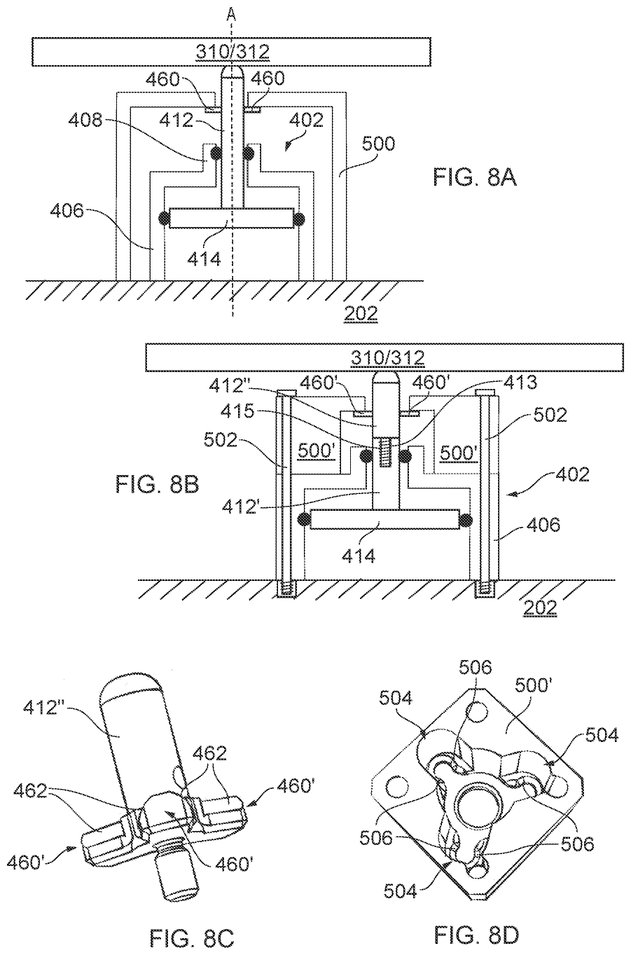

FIGS. 8a and 8b illustrate a pallet lifters according to other embodiments of the invention;

FIGS. 8c and 8d illustrate parts of the piston rod and shroud of the embodiment of FIG. 8b in isolation;

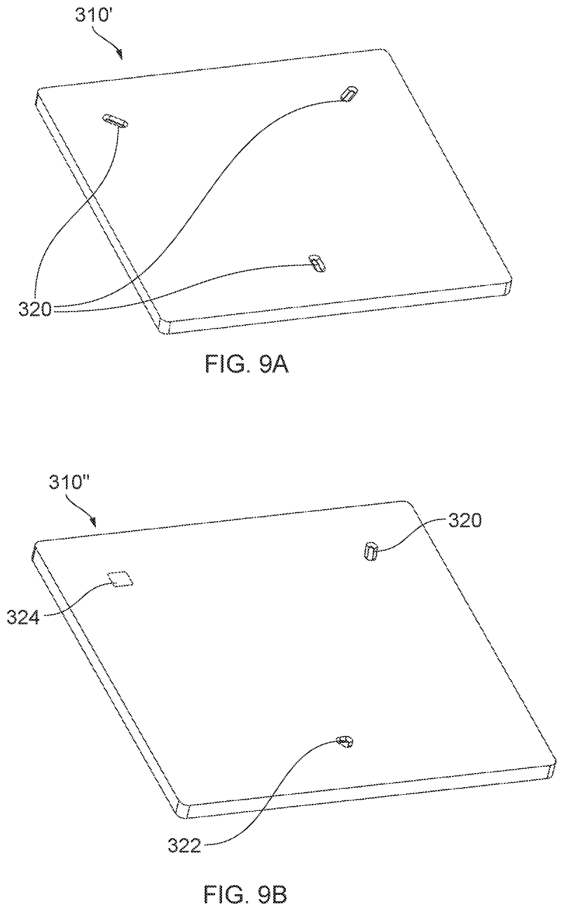

FIGS. 9a and 9b illustrate the underside of a pallet according to a first and a second embodiment of the invention; and

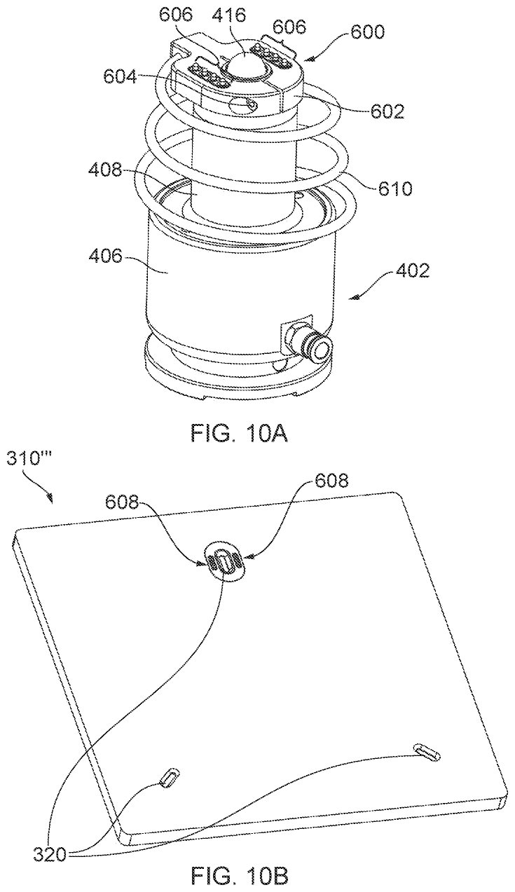

FIGS. 10a and 10b respectively show a pallet lifter with an electrical connector, and the underside of a pallet with a corresponding electrical connector.

Referring to FIG. 1, there is shown an apparatus 100 according to the present invention, comprising an inspection apparatus, in this embodiment a Coordinate Measuring Machine (CMM) 200, and a transfer mechanism, in this embodiment a conveyor pallet loader 300.

In the embodiment shown, the CMM 200 comprises a base 202, and a movement system 204 which provides for repeatable and accurate control of the position of an inspection device (in this case a contact probe 206) in three orthogonal degrees of freedom X, Y and Z. In the embodiment shown, the movement system 204 is a gantry-style movement system, and comprises a raised bridge 205 moveable along the Y-axis, a carriage (not visible in FIG. 1 due to covers on the bridge 205) moveable along the bridge 205 along the X-axis, and a quill/z-column 212 carried by the carriage and moveable relative to the carriage (and hence the bridge) along the Z-axis. As will be understood, other types of inspection apparatus can be used, for example the inspection apparatus could comprise a a bridge-type CMM, a cantilever-type CMM, a non-Cartesian positioning system, a parallel kinematic system, or a robot arm.

In the particular example shown, an articulated head 214 is provided on the lower free end of the quill/z-column 212 for carrying the probe 206. In this case, the articulated head 214 comprises two orthogonal rotational axes. Accordingly, in addition to the three orthogonal linear degrees of freedom X, Y and Z, the probe 206 can be moved about two orthogonal rotational axes (e.g. A and B axes). A machine configured with such an articulated head is commonly known as a 5-axis machine.

Articulated heads for tools and inspection devices are well known, and for example described in WO2007/093789. As will be understood, an articulated head need not necessarily be provided, and for example the probe 206 could be mounted to the quill/z-column 212 via a fixed head which does not provide any rotational degrees of freedom. Optionally, the probe itself can comprise an articulated member so as to facilitate rotation about at least one axis.

As shown in FIG. 1, in this embodiment, the conveyor pallet loader 300 comprises a bridge 302 which extends over the base 202 of the CMM 200. The weight of the bridge 302, and of any part(s) thereon, is transferred in full through to ground via legs 304 which support and hold the bridge 302. Accordingly, the conveyor pallet loader's bridge 304 is slightly raised above the base 202 of the CMM 200 such that bridge is not in contact with the conveyor pallet loader. Accordingly, the conveyor pallet loader 300 is decoupled from the CMM 200.

In this embodiment, the conveyor pallet loader 300 comprises two pallets 310, 312. In use, one or more artefacts can be located on one or more of the two pallets 310, 312. It might be that a calibration artefact 314 is provided on one of the pallets, and a workpiece 316 to be inspected is provided on the other. The pallets 310, 312 can be moved along the bridge 302 of the conveyor pallet loader 300, either manually or automatically. Accordingly, the bridge 302 and/or pallets 310, 312 can comprise bearings, such as mechanical bearings (e.g. roller, ball) and/or air bearings, for facilitating such movement. In the case of the pallets being automatically driven along the bridge 302, one or more actuators, e.g. motors, can be provided. The actuator(s) could be integral with the conveyor pallet loader 300. For example, in the example shown, the bridge 302 of the conveyor pallet loader 300 comprises belts 303 running along the either side of the length of the bridge 302 which can be operated under the control of a motor, for driving the pallets 310, 312 along the bridge 302. Chains (e.g. accumulator chains) could be used instead of the belts 303. Optionally, the actuator(s) could be separate to the conveyor pallet loader 300. For example, an external robot arm could be provided for pushing and/or pulling the pallets 310, 312 along the bridge 302 of the conveyor pallet loader 300.

The apparatus 100 also comprises three pallet lifters 402. In FIG. 1, the pallet lifters are not visible. Rather, in FIG. 1, there are shown three holes 401 in a cover plate 403, through which the pallet lifters can extend when in their extended configuration. The cover plate 403 has been removed from FIG. 2 so that the pallet lifters can be clearly seen. Referring now to FIG. 2, the pallet lifters 402 are rigidly mounted (e.g. bolted or clamped) to the base 202 of the CMM 200. The pallet lifters 402 can be operated so as change between a retracted/lowered configuration and an extended/raised configuration. The pallet lifters 402 are shown in their retracted/lowered configuration in FIGS. 1 and 2. The pallet lifters 402 are located and configured such that when they are in their retracted configuration, a pallet 310, 312 can be moved by the conveyer pallet loader 300 so as to position the pallet over the pallet lifters 402. In this position, the pallet could be said to be in an “inspection location”, because this is a location where a workpiece on the pallet 310, 312 can be/is to be inspected by the CMM 200. When the pallet is in the inspection location, the pallet lifters 402 can then be actuated into their extended/raised configuration so as to engage and lift the pallet 310, 312 and thereby decouple the pallet 310, 312 from the conveyor pallet loader 300 and provide a firm and stable connection between the pallet 310, 312 and ground (in this case via the base 202 of the CMM 200). The CMM 200 can then be operated so as to inspect a workpiece on the pallet 310, 312. After inspection, the pallet lifters 402 can be actuated to return to their retracted configuration such that the pallet 310, 312 can then moved away from the inspection location by the conveyor pallet loader 300.

The pallet lifters will now be described in more detail with reference to FIGS. 3 to 7. FIG. 3a shows a pallet lifter in its retracted/lowered configuration, and FIG. 3b shows a pallet lifter in its extended/raised configuration. In the described embodiment, the pallet lifter comprises a pneumatic actuator.

With reference to FIGS. 3 to 5, the pallet lifter comprises a housing 404 (comprising a main body 406 and a neck 408), and a piston 410 (comprising a piston rod 412 and a piston disc 414). The piston 410 can be moved along an axis A between a lowered/retracted position (shown in FIGS. 3a and 4) and a raised/extended position (shown in FIG. 3b). The piston disc 414 resides in a chamber 420 inside the housing 404, and the piston rod 412 extends, from the piston disc 414, through the neck 408 of the housing 404 and protrudes therefrom through an opening at the free end of the neck 408. A helical spring 428 is compressed between the piston disc 414 and the inside of the free end of the neck 408, thereby urging the piston disc 414 (and hence the piston 410) towards the bottom of the pallet lifter 402/chamber 420 along the axis A. Accordingly, the helical spring 428 biases the piston 410 to its lowered position (and hence the pallet lifter is mechanically biased towards its retracted configuration).

The piston rod 412 comprises a rounded free end (at its end distal the piston disc 414). In this particular embodiment, the rounded free end is provided by a spherical member 416 set in a recessed seat 418 at the free end of the piston rod 412. In the embodiment described the spherical member 416 comprises a tungsten carbide ball, but other materials such as steel can be used instead. The piston 410, housing 406 and neck 408 are made from aluminium, but other materials such as steel can be used instead.

An inlet 422 is provided in the main body 406 of the housing, which in this embodiment can be connected to a compressed air source 470 (see FIG. 1), such that compressed air can be pumped into the chamber 420 below the piston disc 414. A vent 430 is provided for allowing air to enter/exit the part of the chamber 420 above the piston disc 414 as the piston moves up and down. A first O-ring seal 424 is provided between the piston disc 414 and the inside of the housing 404 and a second O-ring seal 426 is provided between the free end of the neck 408 and the piston rod 412. The lateral position of the piston 410 (perpendicular to the axis A) is constrained by the housing 404. In this embodiment, the rotation of the piston 404 about the axis A is prevented by way of a pin 432 extending from the piston disc 414 which is a snug fit within, but can slide in and out of, a slot 434 in the bottom of the main body 406 of the housing 404. Although such an anti-rotation device can be advantageous when the rotational position of the piston is important (e.g. because the piston rod has an electrical connector (not shown) at its end which is to engage the pallet in use), such an anti-rotation device is optional.

The pallet lifter 402 is shown in its retracted/lowered configuration in FIGS. 3a and 4, with the piston 410 retracted into the housing 404 as far as possible (i.e. at its lowermost position). In order to actuate the pallet lifter 402 to its raised configuration, compressed air is pumped into the chamber 420 via the inlet 422. This pushes the piston 410 upwards along the axis A, such that the piston extends/projects further out of the free end of the neck 408 of the housing 404. The piston 410 continues to travel along the axis A until the piston engages a stop provided on the inside of the housing 404. In this embodiment, the location of the piston 410 along the axis A in the extended/raised position is controlled by three discrete, annularly spaced, engagement locations provided between the piston 410 and the stop.

In particular, as shown in more detail in FIGS. 6a and 6b the top face 440 of the piston disc comprises a flat face/rim that extends annularly around the axis A/the piston rod 412, and the stop comprises three discrete, annularly spaced (around the axis A), protruding flat surfaces (so-called “landing pads” or “landing seats”) 442 provided on the bottom edge of the neck part 408 of the pallet lifter's housing 404. The piston 410 continues to travel along the axis A until the top face 440 of the piston disc 414 engages the three landing pads/seats 442 on the inside of the housing 404.

The location of the piston 410 along the axis A in the extended/raised position need not be controlled by three discrete, annularly spaced, engagement locations provided between the piston 410 and the stop. For instance, four or more, engagement locations could be provided. Furthermore, the location of the piston 410 along the axis A in the extended/raised position could be provided by the engagement of two annularly extending flat planar rims (e.g. one on the piston disc and one on the housing). However, providing three discrete, annularly spaced (around the axis A), engagement locations provides a single, stable engagement configuration between the piston 410 and the housing 404, thereby significantly reducing the risk of the piston 410 moving, e.g. rocking, between different engagement configurations when it is in its raised/extended position. This can be important because such motion during inspection of an artefact on a pallet supported by the pallet lifters can adversely affect the accuracy of measurements obtained.

FIG. 7a shows a different embodiment of the pallet lifter. Similar to the above described embodiment, there are three discrete, annularly spaced, engagement locations. However, in this embodiment, they are configured such that the piston 410 is kinematically located with respect to the housing 404 at its extended/raised position. In particular, in this embodiment, three projections 450 (in this case three spherical features, e.g. balls) are provided on the piston disc 414 which are configured to be received in three recesses 452 (in this case V-grooves) when the piston 410 is at its extended/raised position.

As shown in FIG. 9a, the underside of a pallet 310′ comprises three features 320, each arranged to receive the extended end 416 of a pallet lifter. In the embodiment of FIG. 9a, each feature comprises a V-shaped slot, arranged to provide two points of contact with the end 416 of a pallet lifter, and thereby together provide a kinematic joint/link with the three pallet lifters. In the embodiment of FIG. 9b, a first feature 322 comprises a three-sided pyramidal recess, which provides three points of contact with the end 416 of a first pallet lifter, a second feature 320 comprises a V-shaped slot which provides two points of contact with the end 416 of a second pallet lifter, and the third feature 324 comprises a flat surface which provides one point of contact with the end 416 of a third pallet lifter. Together they provide a kinematic joint/link with the three pallet lifters.

In order to actuate the pallet lifter 402 to its lowered/retracted configuration, the pressurised air within the chamber 420 below the piston disc 414 can be released (e.g. via a valve in the air supply line, not shown). To avoid a vacuum in the chamber 420 above the piston disc 414, air can enter the chamber via the vent 430. The piston 410 thereby lowers under the influence of gravity and assisted by the helical spring 428.

In the embodiment described, the pallet lifters are pneumatically operated. In particular, the apparatus comprises a pneumatic system which is operable to use pressured air to actuate the pallet lifters to their raised configuration. Each pallet lifter also comprises a mechanical, helical spring 428 which is configured to bias the pallet lifter towards its retracted configuration, such that the pallet lifter returns to its retracted configuration when the air pressure is reduced.

Optionally, the pallet lifter can be configured differently to that described. For instance, in an alternative embodiment, a spring device could be used to bias the pallet lifter towards its raised configuration, to assist the pneumatic system. In a different embodiment, the pallet lifter could be configured such that a spring biases the pallet lifter towards its raised position instead of a pneumatic system. In a further embodiment a pneumatic system could be provided for actuating the pallet lifter towards its retracted configuration. However, a spring mechanism in such embodiments would likely need to be very strong and physically big in order to be able to lift the pallet and artefact by itself, thereby increasing the size and cost of the pallet lifter. Accordingly, the configuration described above in connection with FIGS. 1 to 7 is advantageous. Although means other than pneumatics could be used to actuate the pallet lifters (e.g. hydraulics/motors), a pneumatic system is particularly advantageous, for instance due to the simplicity and compactness it can provide.

In the embodiment described above, the stop is provided by the housing 404 of the pallet lifter 402. In an alternative embodiment, the stop could be provided by a component separate from the housing. For example, as illustrated in FIG. 8a, the stop could be provided by a shroud 500 which sits over the pallet lifter 402. In this embodiment, three features 460 (only two of which are shown in FIG. 8a) are spaced annularly about the piston rod 412, which engage the shroud 500 when the piston is at its raised position, thereby defining/controlling the location of the piston along the axis A. In the embodiment described, the features 460 are cylindrical rods extending radially from the piston rod 412, which engage V-shaped slots (not shown) on the shroud 500, thereby providing a kinematic location between them. FIG. 8b shows a similar configuration in that the stop is provided by a separate component, but differs in that the separate shroud 500′ sits on top of the main body 406 of the pallet lifter 402. In this embodiment, the shroud 500′ is secured to the base 202 via bolts 502. Tightening of the bolts 502 act to clamp the shroud 500′ and pallet lifter 402 to the base 202.

Also, in this embodiment, it is shown that the pallet lifter's moveable member (in this case the piston rod 412) can comprise multiple parts. In this case, the piston rod comprises a first part 412′ having a threaded socket 413 and a second part 412″ having a threaded pin 415 via which the first 412′ and second 412″ parts can be secured. FIG. 8c shows the second part 412″ in isolation and FIG. 8d shows an underside isometric view of the shroud 500′ of FIG. 8b. As shown, the second part 412″ comprises three radially extending features 460′ for cooperation with three corresponding sockets 504 in the shroud 500′. Each radially extending feature 460′ provides two contact surfaces 462 which engage corresponding contact surfaces 506 on the sockets 504 in the shroud 500′, thereby providing a kinematic link between the piston rod 412 and the shroud 500′. As will be understood, a piston rod comprising multiple parts is equally applicable to the other embodiments described above.

FIG. 10a shows an advantageous optional addition to a pallet lifter. As shown, an electrical connector 600 is provided which moves with the piston rod. In particular, in this embodiment, the electrical connector is provided on the piston rod, and more particularly, it is clamped onto the end of the piston rod 412. The electrical connector 600 comprises a body 602, a clamping bolt 604 and a plurality of electrical contacts 606. The body 602 is snap fitted over the end of the piston rod 412 and clamped in place by tightening the bolt 604, so that it moves with the piston rod 412. A cable 610 for supplying power and/or carrying signals to/from the electrical contacts is connected to the body 602. The electrical contacts 606 face upward, and are configured such that when the piston rod 412 is extended so as to lift a pallet, the electrical contacts 606 can contact, and electrically connect with, corresponding electrical contacts 608 on the underside of a pallet 310′″ (see FIG. 10b). The electrical contacts/pads on the pallet 310′″ can thereby supply power and/or carry signals to/from one or more electrical components in or on the pallet, e.g.: to allow the transmission of temperature data; to confirm the absence/presence/correct seating of the artefact being inspected on the pallet (via fixture proxy sensors); to control fixture electromechanical clamps; to receive data regarding the part being inspected, etc. As will be understood, preferably there is provided some compliance in the electrical connector 600, its contacts 606 and/or the contacts 608 on the pallet such that they do not impact the location of the pallet on the pallet lifter.

In the embodiments described above, the pallet 310/312 is held against the pallet lifters 402 solely due to the gravitational pull on the pallet (and workpiece mounted thereon). However, this need not necessarily be the case. For example, other means for biasing the pallet 310/312 against the pallet lifters 402 could be provided so as to increase the force by which the pallet 310/312 is held against the pallet lifters 402. For instance, one or more magnets, and/or a vacuum suction system, could be provided and configured so as to pull the pallet 310/312 onto the pallet lifters 402. Such means could be provided on the pallet lifter 402 (e.g. around the end of the tip of the piston rod), or separately thereto.

1. An apparatus comprising an inspection apparatus for inspecting an artefact, and a transfer mechanism via which a pallet on which an artefact is located relative to the inspection apparatus can moved to and from an inspection location, and further comprising at least one pallet lifter which can be actuated between a retracted and an extended configuration, configured such that when a pallet is at the inspection location the at least one pallet lifter can be actuated to its extended configuration so as to engage with and lift the pallet and thereby decouple the pallet from the transfer mechanism.

2. An apparatus as claimed in claim 1, in which the transfer mechanism is decoupled from the inspection apparatus.

3. An apparatus as claimed in claim 1, in which the inspection apparatus comprises a movement frame for moving an inspection device relative to a base, and in which the at least one pallet lifter is mounted on the base such that when the at least one pallet lifter engages a pallet, the pallet is connected to ground via the base.

4. An apparatus as claimed in claim 3, in which the transfer mechanism is decoupled from the base.

5. An apparatus as claimed in claim 1, in which the at least one pallet lifter is pneumatically operated.

6. An apparatus as claimed in claim 5, in which the at least one pallet lifter is configured to be actuated into its extended configuration pneumatically, and is configured to be biased into its retracted configuration mechanically.

7. An apparatus as claimed in claim 1, in which the at least one pallet lifter comprises a housing and a member which can be moved between a lowered position and a raised position relative to the housing, in which in the raised position the member extends from the housing more than it does in its lowered position.

8. An apparatus as claimed in claim 6, configured such that the member can be moved to its raised position pneumatically, and comprising at least one spring configured to bias the member toward its lowered position.

9. An apparatus as claimed in claim 7, in which in the raised position a part of the member is biased against a stop.

10. An apparatus as claimed in claim 9, in which the stop is provided on the inside of the housing.

11. An apparatus as claimed in claim 9, in which the stop is provided by a structure which is separate to the housing.

12. An apparatus as claimed in claim 7, in which the location of the member in its raised position is controlled by three discrete engagement locations provided between the member and the stop.

13. An apparatus as claimed in claim 12, in which an engagement location comprises a raised seat on one of the member and the stop, which is configured to be biased against a flat surface provided on the other member.

14. An apparatus as claimed in claim 1, comprising three pallet lifters located so as to interact with and lift a pallet at three separate locations.

15. An apparatus as claimed in claim 14, in which the three pallet lifters are configured to engage with a pallet so as to provide a kinematic joint between the pallet lifters and the pallet.

16. An apparatus as claimed in claim 1, in which at least one of the pallet lifters comprises an electrical connector for providing an electrical connection to an electrical connector on a pallet at the inspection location.

17. An apparatus as claimed in claim 16, in which the electrical connector on the pallet lifter moves with the actuated part of the pallet lifter such that when the pallet lifter is in its extended configuration the electrical connector can connect to a corresponding electrical connector on a pallet at the inspection location, and when the pallet lifter is in its retracted configuration the electrical connector is withdrawn away from a pallet at the inspection location.

18. A pneumatically operable actuator, comprising a housing which houses a piston comprising a piston rod which extends from the housing, and which can be moved between a retracted and an extended position, in which the rest position of the piston at its extended position is controlled by three discrete, engagement locations provided by/between the piston and a stop surface.

19. An apparatus comprising a transfer mechanism for moving a pallet, and at least one pallet lifter which can be actuated between a retracted and an extended configuration, configured such that when the pallet is located over the at least one pallet lifter, the at least one pallet lifter can be actuated to its extended configuration so as to engage with and lift the pallet and thereby decouple the pallet from the transfer mechanism, in which the pallet comprises at least one electrical connector on its underside, and in which at least one of the at least one pallet lifters comprises at least one electrical connector configured such that when the pallet lifter is in its extended configuration the pallet's and the pallet lifter's at least one electrical connectors can contact and electrically connect with each other.

20. An apparatus comprising an inspection apparatus for inspecting an artefact, and a transfer mechanism for moving a pallet on which an artefact is located relative to the inspection apparatus so as to move the pallet to and from an inspection location, in which the transfer mechanism is decoupled from the inspection apparatus.
